(19) United States
(12) Patent Application Publication
(10) Pub. No.: US 2024/0168684 A1
(43) Pub. Date: May 23, 2024

(54) Efficient Deallocation and Reset of Zones in Storage Device

(71) Applicant: Western Digital Technologies, Inc., San Jose, CA (US)

(72) Inventors: Xiaoying LI, Fremont, CA (US); Hyuk-Il KWON, San Jose, CA (US)

(73) Assignee: Western Digital Technologies, Inc., San Jose, CA (US)

(21) Appl. No.: 18/352,162

(22) Filed: Jul. 13, 2023

Related U.S. Application Data
(60) Provisional application No. 63/427,418, filed on Nov. 22, 2022.

(51) Int. Cl. G06F 3/06

(52) U.S. Cl. CPC G06F 3/0659; G06F 3/0613; G06F 3/0631; G06F 3/0679; G06F 12/0292

(57) ABSTRACT

A data storage device for providing efficient deallocation and reset of zones may include a host interface for coupling the data storage device to a host system. The data storage device may also include a controller. The controller may be configured to receive a format or reset zone command from a host system. The controller may also be configured to, in response to receiving the format or reset zone command, extract a time limit from the format or reset command. The controller may also be configured to, within the time limit: set a bitmap for a plurality of memory regions; and perform deallocation or reset of zones of at least a portion of the plurality of memory regions, according to the bitmap. The controller may also return a command completion to the host system.

### CROSS-REFERENCE TO RELATED APPLICATION

This application claims the benefit of U.S. Provisional Application No. 63/427,418, filed on Nov. 22, 2022, the entirety of which is incorporated herein by reference for all purposes.

### BACKGROUND

Zoned namespace (ZNS) is a solid state device (SSD) namespace architecture in which a non-volatile memory is divided into fixed-sized groups of logical addresses, or zones. Each zone may be used for a specific application. For example, a host may cause an SSD to write data associated with different applications into different zones. Zones may spread across a single die or multiple dies, with each zone generally spanning 48 MB or 64 MB of size. The SSD (or a flash storage device) may interface with the host to obtain the defined zones, and maps the zones to blocks in the non-volatile memory (or flash memory). Thus, the host may write separate application-related data into separate blocks of flash memory.

Traditionally, data in an SSD (or a flash storage device) may be invalidated in small chunks (e.g., 4 KB of data), for example, when a host causes the SSD (or the flash storage device) to overwrite the data. To remove the invalidated data from the flash memory, the flash storage device may perform a garbage collection (GC) process in which valid data may be copied to a new block and the invalidated data is erased from the old block. However, in ZNS, a zone is sequentially written before the data in the zone is invalidated, and thus the entire zone may be invalidated at once (e.g., 48 or 64 MB of data). This feature of ZNS reduces or eliminates GC, which in turn reduces write amplification (WA). As a result, ZNS may optimize the endurance of the SSD (or a flash storage device), as well as improve the consistency of input/output (I/O) command latencies.

There are architectures similar to ZNS for managing regions of data, such as explicit streams or region management. Both ZNS and other data-placement systems (such as the Open Channel) use a mechanism in which the host may implicitly or explicitly cause the SSD (or the flash storage device) to open a specific range for write, which may be mapped to an open block or to a holding buffer. In non-ZNS advanced data-placement, a region may be written in any order, and closed by the host (via the SSD) or by a timeout. Once closed, a region is expected to stay immutable, although the host is permitted to overwrite it (via the SSD) at any time, incurring a cost in write amplification. Both regions and zones have a limited open lifetime. Once a region or zone is open for longer than the time limit, the SSD or a flash storage device) may close it autonomously in order to maintain resource availability. Host-managed streaming systems allow out of order writes within each provided region.

The ZNS specification defines a state machine for zones in ZNS devices. There is a state machine associated with each zone. The state machine controls the operational characteristics of each zone. The state machine consists of the following states: empty, implicitly opened, explicitly opened, closed, full, read only, and offline. If a zoned namespace is formatted with a format non-volatile memory (NVM) command or created with a namespace management command, the zones in the zoned namespace are initialized to either the empty state or the offline state. The initial state of a zone state machine may be set as a result of an NVM subsystem reset. Total zone number may be up to 650,000 for a 32 Terabyte device. So resetting all zones may take a large amount of time, which is likely to exceed the command timeout for ZNS reset all zone command and format NVM command. Hence, there is a need for efficient deallocation and resets in ZNS devices.

The description provided in the background section should not be assumed to be prior art merely because it is mentioned in or associated with the background section. The background section may include information that describes one or more aspects of the subject technology, and the description in this section does not limit the invention.

### BRIEF DESCRIPTION OF THE DRAWINGS

A detailed description will be made with reference to the accompanying drawings:

FIG. 1 is a block diagram illustrating components of an example data storage system, according to one or more embodiments.

FIG. 2 illustrates an example command processing for format NVM and reset all zone command, according to one or more embodiments.

FIG. 3A illustrates an example scenario for deallocation and/or zone reset, according to one or more embodiments.

FIG. 3B illustrates another example scenario for deallocation and/or zone reset, according to one or more embodiments.

FIG. 4 illustrates an example of a zone reset bitmap and a mapping between bits of the bitmap and zone numbers, according to one or more embodiments.

FIG. 5 is a flowchart illustrating an example process for efficient deallocation and reset of zones in a data storage device, according to one or more embodiments.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology may be practiced without these specific details. In some instances, structures and components are shown in block diagram form in order to avoid obscuring the concepts of the subject technology. Like components are labeled with identical element numbers for ease of understanding.

The present description relates in general to data storage systems and methods, and more particularly to, for example, without limitation, providing efficient deallocation and reset of zones in a data storage device. A method is provided for efficiently resetting a large number of zones for zoned namespace storage (ZNS) devices to reduce the latency for format NVM and reset all zones command. The method may use the format NVM and reset all zone command time for deallocation (update the logical to physical mapping table to indicate the logical space is erased) and zone reset. A SSD firmware may perform deallocation and zone reset in background, because the time to execute all the deallocation and zone reset may take too long and cause command timeout. Instead, a flash translation layer may setup the deallocation or reset bitmap during command time and return completion. The actual deallocation and zone reset may happen in background. However, if too much such background operations are accumulated, the storage device may eventually become low on buffer space (e.g., single-level cell space) and garbage collection may be required which may further slowdown the system performance. Accordingly, the method described herein may strike a balance between performing deallocations and/or resets immediately and postponing and/or performing such operations in the background. A bitmap structure (e.g., how many bits are used to represent a group of zones) may be selected appropriately.

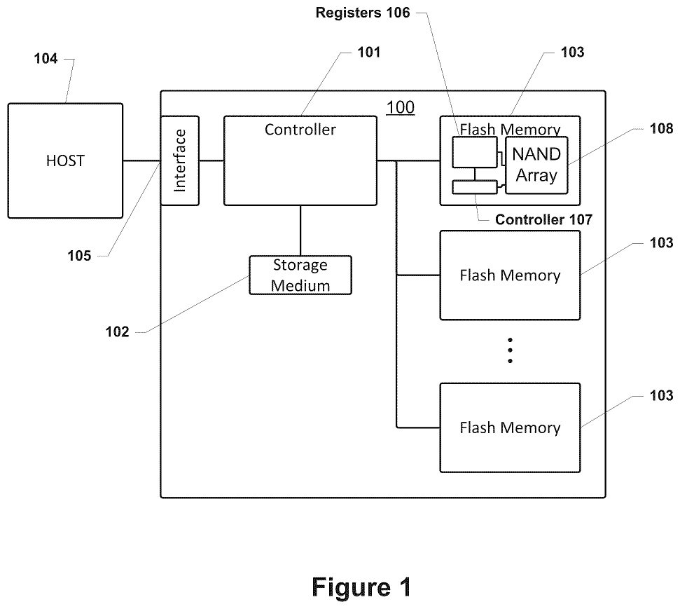

FIG. 1 is a block diagram illustrating components of an example data storage system, according to aspects of the subject technology. A data storage system may be sometimes referred to as a system, a data storage device, a storage device, or a device. As depicted in FIG. 1, in some aspects, a data storage system 100 (e.g., a solid-state drive (SSD)) includes a data storage controller 101, a storage medium 102, and a flash memory array including one or more flash memory 103. The controller 101 may use the storage medium 102 for temporary storage of data and information used to manage the data storage system 100. The controller 101 may include several internal components (not shown), such as a read-only memory, other types of memory, a flash component interface (e.g., a multiplexer to manage instruction and data transport along a serial connection to the flash memory 103), an input/output (I/O) interface, error correction circuitry, and the like. In some aspects, the elements of the controller 101 may be integrated into a single chip. In other aspects, these elements may be separated on their own personal computer (PC) board.

In some implementations, aspects of the subject disclosure may be implemented in the data storage system 100. For example, aspects of the subject disclosure may be integrated with the function of the data storage controller 101 or may be implemented as separate components for use in conjunction with the data storage controller 101.

The controller 101 may also include a processor that may be configured to execute code or instructions to perform the operations and functionality described herein, manage request flow and address mappings, and to perform calculations and generate commands. The processor of the controller 101 may be configured to monitor and/or control the operation of the components in the data storage controller 101. The processor may be a microprocessor, a microcontroller, a digital signal processor (DSP), an application specific integrated circuit (ASIC), a field programmable gate array (FPGA), a programmable logic device (PLD), a controller, a state machine, gated logic, discrete hardware components, or a combination of the foregoing. One or more sequences of instructions may be stored as firmware on read-only-memory (ROM) within the controller 101 and/or its processor. One or more sequences of instructions may be software stored and read from the storage medium 102, the flash memory 103, or received from a host device 104 (e.g., via a host interface 105). ROM, the storage medium 102, the flash memory 103, represent examples of machine or computer readable media on which instructions/code executable by the controller 101 and/or its processor may be stored. Machine or computer readable media may generally refer to any medium or media used to provide instructions to the controller 101 and/or its processor, including volatile media, such as dynamic memory used for the storage media 102 or for buffers within the controller 101, and non-volatile media, such as electronic media, optical media, and magnetic media.

In some aspects, the controller 101 may be configured to store data received from the host device 104 in the flash memory 103 in response to a write command from the host device 104. The controller 101 is further configured to read data stored in the flash memory 103 and to transfer the read data to the host device 104 in response to a read command from the host device 104. A host device 104 may be sometimes referred to as a host, a host system, or a host computer.

The host device 104 represents any device configured to be coupled to the data storage system 100 and to store data in the data storage system 100. The host device 104 may be a computing system such as a personal computer, a server, a workstation, a laptop computer, a personal digital assistant (PDA), a smart phone, or the like. Alternatively, the host device 104 may be an electronic device such as a digital camera, a digital audio player, a digital video recorder, or the like.

In some aspects, the storage medium 102 represents volatile memory used to temporarily store data and information used to manage the data storage system 100. According to aspects of the subject technology, the storage medium 102 is random access memory (RAM), such as double data rate (DDR) RAM. Other types of RAMs may be also used to implement the storage medium 102. The memory 102 may be implemented using a single RAM module or multiple RAM modules. While the storage medium 102 is depicted as being distinct from the controller 101, those skilled in the art will recognize that the storage medium 102 may be incorporated into the controller 101 without departing from the scope of the subject technology. Alternatively, the storage medium 102 may be a non-volatile memory, such as a magnetic disk, flash memory, peripheral SSD, and the like.

As further depicted in FIG. 1, the data storage system 100 may also include the host interface 105. The host interface 105 may be configured to be operably coupled (e.g., by wired or wireless connection) to the host device 104, to receive data from the host device 104 and to send data to the host device 104. The host interface 105 may include electrical and physical connections, or a wireless connection, for operably coupling the host device 104 to the controller 101 (e.g., via the I/O interface of the controller 101). The host interface 105 may be configured to communicate data, addresses, and control signals between the host device 104 and the controller 101. Alternatively, the I/O interface of the controller 101 may include and/or be combined with the host interface 105. The host interface 105 may be configured to implement a standard interface, such as a small computer system interface (SCSI), a serial-attached SCSI (SAS), a fiber channel interface, a peripheral component interconnect express (PCIe), a serial advanced technology attachment (SATA), a universal serial bus (USB), or the like. The host interface 105 may be configured to implement only one interface. Alternatively, the host interface 105 (and/or the I/O interface of controller 101) may be configured to implement multiple interfaces, which may be individually selectable using a configuration parameter selected by a user or programmed at the time of assembly. The host interface 105 may include one or more buffers for buffering transmissions between the host device 104 and the controller 101. The host interface 105 (or a front end of the controller 101) may include a submission queue 110 to receive commands from the host device 104. For input-output (I/O), the host device 104 may send commands, which may be received by the submission queue 110 (e.g., a fixed size circular buffer space). In some aspects, the submission queue may be in the controller 101. In some aspects, the host device 104 may have a submission queue. The host device 104 may trigger a doorbell register when commands are ready to be executed. The controller 101 may then pick up entries from the submission queue in the order the commands are received, or in an order of priority.

The flash memory 103 may represent a non-volatile memory device for storing data. According to aspects of the subject technology, the flash memory 103 includes, for example, a not-and (NAND) flash memory. The flash memory 503 may include a single flash memory device or chip, or (as depicted in FIG. 1) may include multiple flash memory devices or chips arranged in multiple channels. The flash memory 103 is not limited to any capacity or configuration. For example, the number of physical blocks, the number of physical pages per physical block, the number of sectors per physical page, and the size of the sectors may vary within the scope of the subject technology.

The flash memory may have a standard interface specification so that chips from multiple manufacturers can be used interchangeably (at least to a large degree). The interface hides the inner working of the flash and returns only internally detected bit values for data. In aspects, the interface of the flash memory 103 is used to access one or more internal registers 106 and an internal flash controller 107 for communication by external devices (e.g., the controller 101). In some aspects, the registers 106 may include address, command, and/or data registers, which internally retrieve and output the necessary data to and from a NAND memory cell array 108. A NAND memory cell array 108 may be sometimes referred to as a NAND array, a memory array, or a NAND. For example, a data register may include data to be stored in the memory array 108, or data after a fetch from the memory array 108 and may also be used for temporary data storage and/or act like a buffer. An address register may store the memory address from which data will be fetched to the host device 104 or the address to which data will be sent and stored. In some aspects, a command register is included to control parity, interrupt control, and the like. In some aspects, the internal flash controller 107 is accessible via a control register to control the general behaviour of the flash memory 103. The internal flash controller 107 and/or the control register may control the number of stop bits, word length, receiver clock source, and may also control switching the addressing mode, paging control, coprocessor control, and the like.

In some aspects, the registers 106 may also include a test register. The test register may be accessed by specific addresses and/or data combinations provided at the interface of flash memory 103 (e.g., by specialized software provided by the manufacturer to perform various tests on the internal components of the flash memory). In further aspects, the test register may be used to access and/or modify other internal registers, for example the command and/or control registers. In some aspects, test modes accessible via the test register may be used to input or modify certain programming conditions of the flash memory 103 (e.g., read levels) to dynamically vary how data is read from the memory cells of the memory arrays 108. The registers 106 may also include one or more data latches coupled to the flash memory 103.

It should be understood that in all cases data may not always be the result of a command received from the host 104 and/or returned to the host 104. In some aspects, the controller 101 may be configured to execute a read operation independent of the host 104 (e.g., to verify read levels or BER). The predicate words “configured to,” “operable to,” and “programmed to” as used herein do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

The controller 101 may perform the operations identified in blocks 502-514. The controller 101 may cause the operations identified in blocks 502-514 to occur, or the controller 101 may provide instructions to cause or facilitate the controller 107 (and the registers 106) to perform operations identified in blocks 502-514.

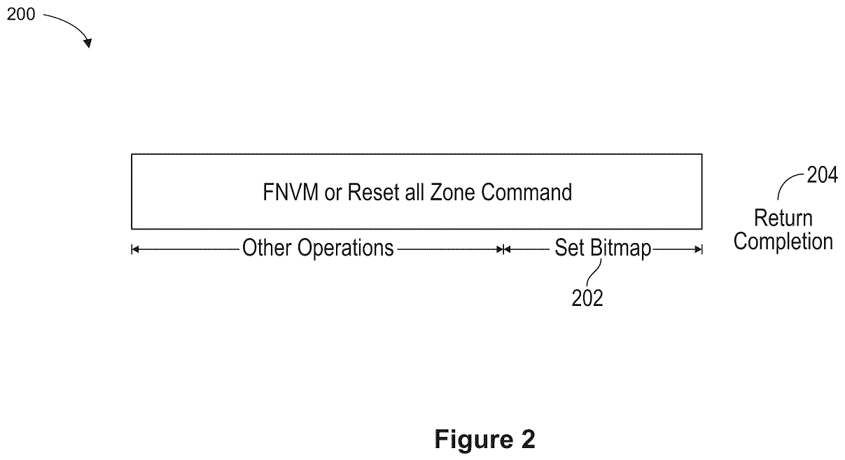

FIG. 2 illustrates an example command processing 200 for format NVM and reset all zone command, according to one or more embodiments. Some aspects may return command completion 204 after setting up a bitmap 202 for deallocation and/or reset, following other operations, such as the flash translation layer (FTL) resetting data structures of other modules of the controller 101, for the format NVM and reset all zone command. Setting up a bitmap may take a short time (in comparison to total reset and/or deallocation), so a completion notification may be returned to a host for format NVM and/or reset all zone command quickly.

Some aspects may use time specified by a host in a format NVM and/or reset all zone command time. In some aspects, device firmware may perform as much as deallocation and zone reset during the allowed command time, then return completion to host. In some aspects, the firmware may not accumulate too much background operation.

In some aspects, when a flash translation layer (FTL) starts to process format NVM and/or reset all zone command, a timer may be started. The expiration time may be set to command timeout value minus some buffer time. The format NVM and/or reset all zone command may continue with deallocation and zone reset after setting up the bitmap until the timer expires or all deallocation and zone resets are completed. Subsequently, the FTL may return command completion to a host.

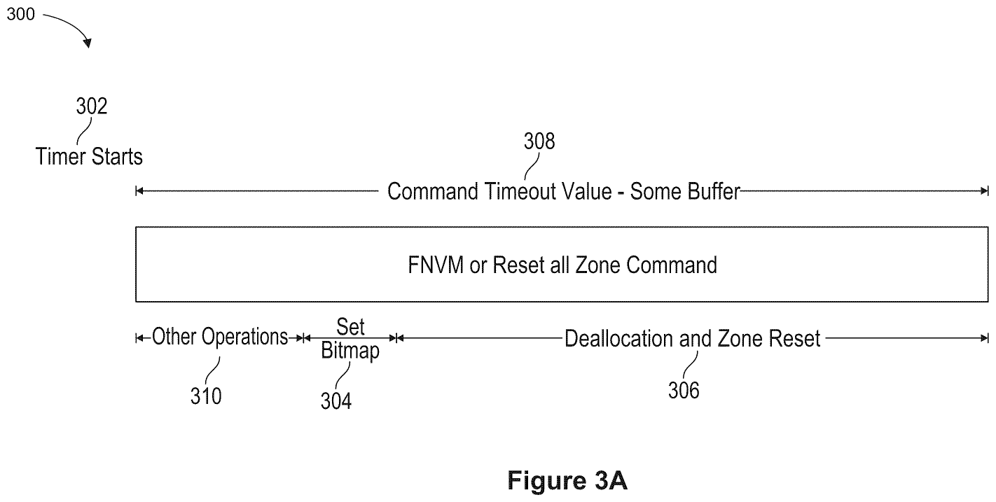

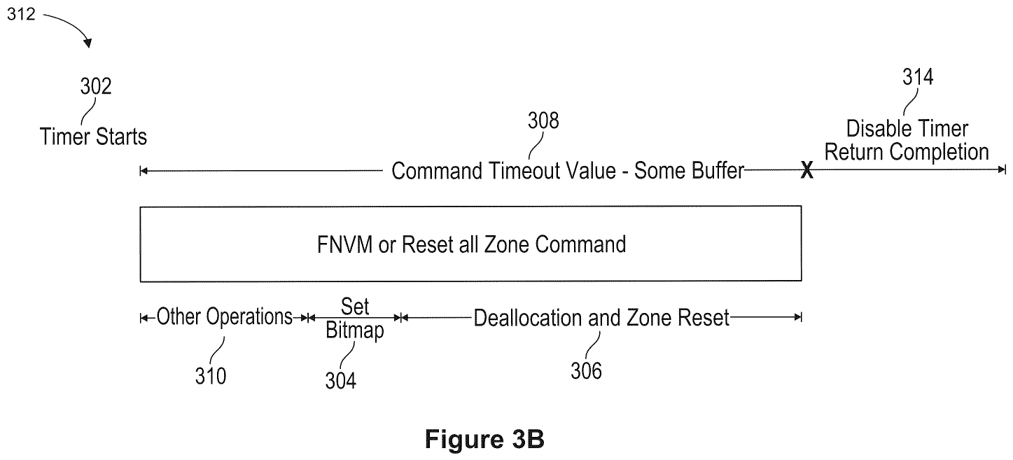

FIG. 3A illustrates an example scenario 300 for deallocation and/or zone reset, according to one or more embodiments. The example shows a timer started (302) after a format NVM or reset all zone command is received from a host. The timer may be set to a command time out value minus a buffer value (e.g., 10% of the timeout value). This example corresponds to a situation when there are more deallocation and/or zone reset to perform when the timer expires. In this scenario, after the timer starts, the FTL may perform other operations (310) (e.g., reset data structures for other modules of the controller 101), set the bitmap (304), perform a portion of the deallocation and zone reset (306), and return command completion to the host; the FTM may then continue the deallocation and zone reset in background. FIG. 3B illustrates another example scenario 312 for deallocation and/or zone reset, according to one or more embodiments. In this example, all deallocation and zone reset are completed before the timer expires. In this case, the FTL may disable the timer and return command completion to host (314). Some aspects may allow as much deallocation and zone reset to be performed during format NVM and reset all zones command time, to leave less work to be done in background.

If a storage device is power cycled or loses power when there is a pending zone reset operation, the zone reset operation should resume after power is resumed. To reduce the amount of data to be saved across power cycle, N zones may be grouped together and may correspond to one bit in a bitmap. Whenever the system has bandwidth, the background zone reset operation may go through the bitmap from the first bit to the last bit. Each time N zones corresponding to one bit in the bitmap may be reset, the bit in the bitmap may be cleared and the reset operation may yield to other operations to avoid impact to quality of service (QoS) and other command's latency.

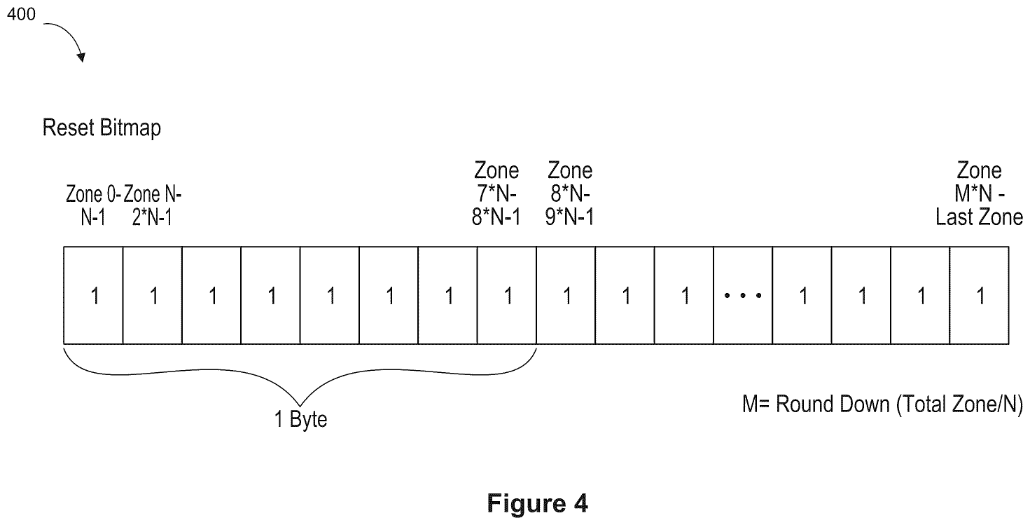

FIG. 4 illustrates an example 400 of a zone reset bitmap and a mapping between bits of the bitmap and zone numbers, according to one or more embodiments. Suppose there are Total Zone number of zones. The zone reset bitmap may include M bits, where M may be calculated by rounding down Total Zone divided by N. The value of N may be determined based on a number of factors. In some aspects, the memory region size (sometimes referred to as N) may be selected according to the following considerations. N may not be too large, so that the time to handle each bit is not too long. The firmware may yield to the host input/output quickly. N may not be too small that the firmware enters and exits background operation (for reset and/or deallocation) too often. Repeated entry and exit may also cause overhead. Additionally, if N is too small, the bitmap may take up more space. N may be determined based on one or more of these factors. The bits in the bitmap correspond to zones 0 to N-1, N to 2 times N-1, . . . M times N to the last zone, respectively. The example shows an initial state of the bitmap (all bits are 1) where the corresponding zones remain to be reset and/or deallocated. After a reset and/or deallocation, the corresponding bit for the zones may be reset to 0.

To achieve zone state integrity, the following special handlings may be implemented, according to one or more embodiments. If any commands that needs to access or update the zone state information, and the requested zone is in the reset bitmap, reset zone may be performed before the access or update of its state information. If there are zones pending reset, and host tries to implicitly, explicitly open a zone or set descriptor for a zone and the total active zone number reaches a predetermined maximum value, one active zone may be picked up and reset, along with the other N-1 zones in the same reset bitmap. If there are zones pending reset, and host tries to implicitly or explicitly open a zone set descriptor for a zone and the total empty zone number reaches a predetermined minimum value, one active zone may be picked up and reset, along with the other N-1 zones in the same reset bitmap.

In this way, the techniques described herein may be used to avoid command timeout for format NVM and reset all zones command for ZNS devices.

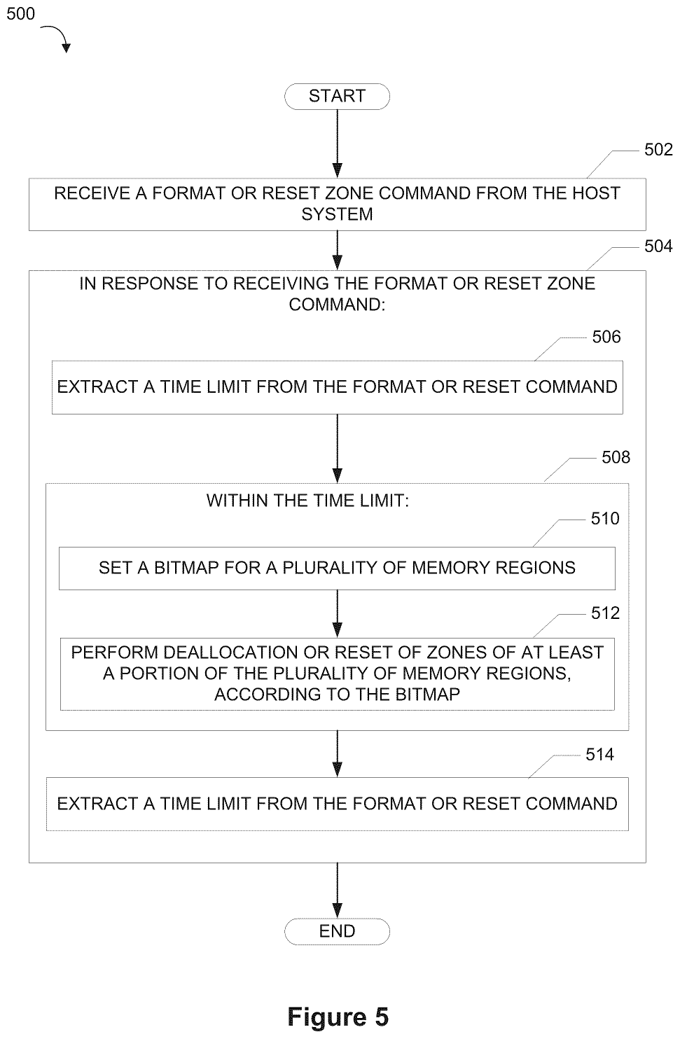

It may be instructive to describe the structures shown in FIGS. 1, 2, 3A, 3B and 4, with respect to FIG. 5, a flowchart illustrating an example process 500 for efficient deallocation and reset of zones in a storage device, according to one or more embodiments. One or more blocks of FIG. 5 may be executed by a computing system (including, e.g., a controller of a flash memory, a data storage controller of a data storage system or a solid state storage device (SSD), a processor, or the like). Example of a computing system or a controller may be the controller 101. Similarly, a non-transitory machine-readable medium may include machine-executable instructions thereon that, when executed by a computer or machine, perform the blocks of FIG. 5. The steps of process 500 may be implemented as hardware, firmware, software, or a combination thereof. For example, a data storage device (e.g., the storage device 100) includes a submission queue for receiving host commands from a host system. The data storage device also includes a controller (e.g., the controller 101).

The controller 101 may be configured to receive (502) a format or reset zone command from a host system. The controller 101 may also be configured to perform one or more of the following steps in response (504) to receiving the format or reset zone command. The controller 101 may be configured to extract (506) a time limit from the format or reset command. The controller 101 may also be configured to, perform (508) within the time limit: set (510) a bitmap for a plurality of memory regions; and perform (512) deallocation or reset of zones of at least a portion of the plurality of memory regions, according to the bitmap. The controller 101 may also be configured to return (514) a command completion to the host system. Each memory region may correspond to a zone specified by the format or reset zone command.

In some aspects, the controller 101 may be further configured to: prior to generating the bitmap, start a timer for the time limit; and upon expiration of the timer, stop the deallocation or the reset of zones. Logical to physical table deallocation and/or zone reset may still be performed in background.

In some aspects, the controller 101 may be further configured to: in accordance with a determination that the deallocation or reset of zones is complete before the expiration of the timer, returning the command completion to the host system.

In some aspects, the format or reset zone command corresponds to either a format non-volatile memory (FNVM) command or a reset all zone command.

In some aspects: the time limit corresponds to an FNVM command time for deallocation; and the deallocation includes updating a logical to physical mapping table to indicate that one or more logical spaces are erased. The deallocation may include FTL table deallocation and/or logical to physical table deallocation.

In some aspects, the controller 101 may be further configured to: after expiration of the time limit: perform deallocation or reset of zones of a remaining portion of the plurality of memory regions according to the bitmap in a background operation.

In some aspects, the controller 101 may be further configured to perform the background operation when the data storage device has bandwidth (e.g., when there is idle time, no host operation). In some aspects, the background operation may be scheduled and/or executed in a weighted round robin fashion with other operations (e.g., background read scrub, control data synchronization) in the controller 101.

In some aspects, the controller 101 may be further configured to: perform the background operation by scanning the bitmap. The scanning may include one or more instances of scanning the bitmap from the first bit to the last bit. Each of the one or more instances may include (i) resetting a group of zones corresponding to a one bit in the bitmap and (ii) clearing the one bit in the bitmap. In some aspects, the controller 101 may select a zone to reset from last bit when the host needs to open a new zone (which does not correspond to a bit in the bitmap), but the total active zone number is over a predetermined maximum value. For active and open resources, zones in implicitly opened, explicitly opened, and closed states, may be limited by a maximum active resources field. This field may be used to determine the maximum value. Another example is maximum active resources (MAR) in zoned namespace command set.

In some aspects, the controller 101 may be further configured to: yield to operations other than the background operation, to avoid impact to quality-of-service (QoS) and other one or more operations' latency constraints. For example, the background operation may be given lower priority, while host input/output operations may be given higher priority and/or time to execute.

In some aspects, the controller 101 may be further configured to: resume zone reset operation after a power cycle or loss of power when there is a pending zone reset operation, according to the bitmap.

In some aspects, the controller 101 may be further configured to generate the bitmap by allocating a bit for each group of memory regions of the plurality of memory regions. In some aspects, the memory region size (sometimes referred to as N) may be selected according to the following considerations. N may not be too large, so that the time to handle each bit is not too long. The firmware may yield to the host input/output quickly. N may not be too small that the firmware enters and exits background operation (for reset and/or deallocation) too often. Repeated entry and exit may also cause overhead. Additionally, if N is too small, the bitmap may take up more space. N may be determined based on one or more of these factors.

In some aspects, the controller 101 may be further configured to: in accordance with a determination that (i) a host command received from the host system requires access to or needs to update a state information for a first zone, and (ii) the first zone is in the bitmap, perform reset for the first zone before accessing or updating the state information for the first zone.

In some aspects, the controller 101 may be further configured to: in accordance with a determination that (i) there are zones pending reset according to the bitmap, (ii) the host system is attempting to implicitly or explicitly open a zone or set a descriptor for a zone, and (iii) a total number of active zones has reached a predetermined maximum value, select and reset one active zone along with other zones corresponding to a same bit in the bitmap as the one active zone. The zone referred to in (ii) may be any zone that host attempts to change state for. An active zone may be a zone the controller 101 selects to reset to reduce the total active zone number by one. Because reset occurs from bit 0 and forward, it is more likely a lot of zones in front of the list have been reset. So the controller 101 may have to search more bits to find one that is set, if the controller 101 has to search from bit 0 forward. Accordingly, in some aspects, the controller 101 may select the active zone from the last bit backwards to shorten the search time.

In some aspects, the controller 101 may be further configured to, in accordance with a determination that (i) there are zones pending reset according to the bitmap, (ii) the host system is attempting to implicitly or explicitly open a zone or set a descriptor for a zone, which may include any zone that allows these operations, and (iii) a total number of empty zones has reached a predetermined minimum value, select and reset one active zone along with other zones corresponding to a same bit in the bitmap as the one active zone. The predetermined minimum value may be a minimum empty zone that may not be set by the host, but may be predetermined based on an application or a customer requirement, so as to maintain a minimum number of empty zones for the firmware to guarantee maximum parallelism when writing to the data storage device.

In some aspects, the controller 101 may be further configured to perform operations for maintaining zone state integrity for the plurality of memory regions. In some aspects, the controller 101 may take into account open resource limit in a ZNS specification for maintaining zone state integrity.

In some aspects, the data storage device 100 may be a host-managed stream device. The plurality of memory regions may correspond to zones that are managed by the host system 104. A host-managed stream device may include any devices based on a data-placement system (e.g., ZNS described above, flexible data placement (FDP)). In some aspects, the data storage device 100 may be a host-managed stream device or multiple endurance group devices. The data storage device 100 may include any storage that has a bulk of logical to physical address mapping to be deallocated.

In some aspects, the controller 101 includes a flash translation layer (FTL) configured to generate the bitmap and perform the deallocation or reset of zones. The FTL may include a logical to physical (L2P) table and/or zone state information, which may be used to generate the bitmap and/or perform the deallocation or reset of zones.

Various examples of aspects of the disclosure are described below. These are provided as examples, and do not limit the subject technology.

One or more aspects of the subject technology provide a data storage device that may include a host interface and a controller. The controller may be configured to: receive a format or reset zone command from the host system; in response to receiving the format or reset zone command: extract a time limit from the format or reset command; within the time limit: set a bitmap for a plurality of memory regions; and perform deallocation or reset of zones of at least a portion of the plurality of memory regions, according to the bitmap; and return a command completion to the host system.

In some aspects, the controller may be further configured to: prior to generating the bitmap, start a timer for the time limit; and upon expiration of the timer, stop the deallocation or the reset of zones.

In some aspects, the controller may be further configured to: in accordance with a determination that the deallocation or reset of zones is complete before the expiration of the timer, returning the command completion to the host system.

In some aspects, the format or reset zone command corresponds to either a format non-volatile memory (FNVM) command or a reset all zone command.

In some aspects, the time limit corresponds to an FNVM command time for deallocation, and the deallocation comprises updating a logical to physical mapping table to indicate that one or more logical spaces are erased.

In some aspects, the controller may be further configured to: after expiration of the time limit: perform deallocation or reset of zones of a remaining portion of the plurality of memory regions according to the bitmap in a background operation.

In some aspects, the controller may be further configured to: perform the background operation when the data storage device has bandwidth.

In some aspects, the controller may be further configured to: perform the background operation by scanning the bitmap, wherein the scanning comprises one or more instances of scanning the bitmap from the first bit to the last bit, each of the one or more instances comprises (i) resetting a group of zones corresponding to a one bit in the bitmap and (ii) clearing the one bit in the bitmap.

In some aspects, the controller may be further configured to: yield to operations other than the background operation, to avoid impact to quality-of-service (QoS) and other one or more operations' latency constraints.

In some aspects, the controller may be further configured to: resume zone reset operation after a power cycle or loss of power when there is a pending zone reset operation, according to the bitmap.

In some aspects, the controller may be further configured to: generate the bitmap by allocating a bit for each group of memory regions of the plurality of memory regions.

In some aspects, the controller may be further configured to: in accordance with a determination that (i) a host command received from the host system requires access to or needs to update a state information for a first zone, and (ii) the first zone is in the bitmap, perform reset for the first zone before accessing or updating the state information for the first zone.

In some aspects, the controller may be further configured to: in accordance with a determination that (i) there are zones pending reset according to the bitmap, (ii) the host system is attempting to implicitly or explicitly open a zone or set a descriptor for a zone, and (iii) a total number of active zones has reached a predetermined maximum value, select and reset one active zone along with other zones corresponding to a same bit in the bitmap as the one active zone.

In some aspects, the controller may be further configured to: in accordance with a determination that (i) there are zones pending reset according to the bitmap, (ii) the host system is attempting to implicitly or explicitly open a zone or set a descriptor for a zone, and (iii) a total number of empty zones has reached a predetermined minimum value, select and reset one active zone along with other zones corresponding to a same bit in the bitmap as the one active zone.

In some aspects, the controller may be further configured to: perform operations for maintaining zone state integrity for the plurality of memory regions.

In some aspects, the data storage device is a host-managed stream device, wherein the plurality of memory regions correspond to zones that are managed by the host system.

In some aspects, the controller comprises a flash translation layer configured to generate the bitmap and perform the deallocation or reset of zones.

In other aspects, methods are provided for efficient deallocation and reset of zones in data storage devices. According to some aspects, a method may be implemented using one or more controllers for one or more data storage devices. The method may include: receiving a format or reset zone command from a host system; in response to receiving the format or reset zone command: extracting a time limit from the format or reset command; within the time limit: generating a bitmap for a plurality of memory regions; and performing deallocation or reset of zones of at least a portion of the plurality of memory regions, according to the bitmap; and returning a command completion to the host system.

In further aspects, a system may include: means for receiving a format or reset zone command from a host system; means for, in response to receiving the format or reset zone command: means for extracting a time limit from the format or reset command; within the time limit: means for generating a bitmap for a plurality of memory regions; and means for performing deallocation or reset of zones of at least a portion of the plurality of memory regions, according to the bitmap; and means for returning a command completion to the host system.

Disclosed are systems and methods providing active time-based prioritization in host-managed stream devices. Thus, the described methods and systems provide performance benefits that improve the functioning of a storage device.

It is understood that other configurations of the subject technology will become readily apparent to those skilled in the art from the detailed description herein, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a “configuration” may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. A data storage device, comprising:
a host interface for coupling the data storage device to a host system; and
a controller configured to:
receive a format or reset zone command from the host system;
in response to receiving the format or reset zone command:
extract a time limit from the format or reset command;
within the time limit:
set a bitmap for a plurality of memory regions; and
perform deallocation or reset of zones of at least a portion of the plurality of memory regions, according to the bitmap; and
return a command completion to the host system.

2. The data storage device of claim 1, wherein the controller is further configured to:
prior to setting the bitmap, start a timer for the time limit; and
upon expiration of the timer, stop the deallocation or the reset of zones.

3. The data storage device of claim 2, wherein the controller is further configured to:
in accordance with a determination that the deallocation or reset of zones is complete before the expiration of the timer, return the command completion to the host system.

4. The data storage device of claim 1, wherein the format or reset zone command corresponds to either a format non-volatile memory (FNVM) command or a reset all zone command.

5. The data storage device of claim 4, wherein:
the time limit corresponds to an FNVM command time for deallocation; and
the deallocation comprises updating a logical to physical mapping table to indicate that one or more logical spaces are erased.

6. The data storage device of claim 1, wherein the controller is further configured to:
after expiration of the time limit:
perform deallocation or reset of zones of a remaining portion of the plurality of memory regions according to the bitmap in a background operation.

7. The data storage device of claim 6, wherein the controller is further configured to:
perform the background operation when the data storage device has bandwidth.

8. The data storage device of claim 6, wherein the controller is further configured to:
perform the background operation by scanning the bitmap, wherein the scanning comprises one or more instances of scanning the bitmap from a first bit to a last bit, each of the one or more instances comprises (i) resetting a group of zones corresponding to a one bit in the bitmap and (ii) clearing the one bit in the bitmap.

9. The data storage device of claim 6, wherein the controller is further configured to:
yield to operations other than the background operation, to avoid impact to quality-of-service (QoS) and other one or more operations' latency constraints.

10. The data storage device of claim 1, wherein the controller is further configured to:
resume zone reset operation after a power cycle or loss of power when there is a pending zone reset operation, according to the bitmap.

11. The data storage device of claim 1, wherein the controller is further configured to:
set the bitmap by setting a bit for each group of memory regions of the plurality of memory regions.

12. The data storage device of claim 1, wherein the controller is further configured to:
in accordance with a determination that (i) a host command received from the host system requires access to or needs to update a state information for a first zone, and (ii) a bit corresponding to the first zone is set in the bitmap, perform reset for the first zone before accessing or updating the state information for the first zone.

13. The data storage device of claim 1, wherein the controller is further configured to:
in accordance with a determination that (i) there are zones pending reset according to the bitmap, (ii) the host system is attempting to implicitly or explicitly open a zone or set a descriptor for a zone, and (iii) a total number of active zones has reached a predetermined maximum value, select and reset one active zone along with other zones corresponding to a same bit in the bitmap as the one active zone.

14. The data storage device of claim 1, wherein the controller is further configured to:
in accordance with a determination that (i) there are zones pending reset according to the bitmap, (ii) the host system is attempting to implicitly or explicitly open a zone or set a descriptor for a zone, and (iii) a total number of empty zones has reached a predetermined minimum value, select and reset one active zone along with other zones corresponding to a same bit in the bitmap as the one active zone.

15. The data storage device of claim 1, wherein the controller is further configured to:
perform operations for maintaining zone state integrity for the plurality of memory regions.

16. The data storage device of claim 1, wherein the data storage device is a host-managed stream device, wherein the plurality of memory regions correspond to zones that are managed by the host system.

17. A method implemented using one or more controllers for one or more data storage devices, the method comprising:
receiving a format or reset zone command from a host system;
in response to receiving the format or reset zone command:
extracting a time limit from the format or reset command;
within the time limit:
setting a bitmap for a plurality of memory regions; and
performing deallocation or reset of zones of at least a portion of the plurality of memory regions, according to the bitmap; and
returning a command completion to the host system.

18. The method of claim 17, further comprising:
prior to setting the bitmap, starting a timer for the time limit; and
upon expiration of the timer, stopping the deallocation or the reset of zones.

19. The method of claim 18, further comprising:
in accordance with a determination that the deallocation or reset of zones is complete before the expiration of the timer, returning the command completion to the host system.

20. A system, comprising:
means for receiving a format or reset zone command from a host system;
means for, in response to receiving the format or reset zone command:
means for extracting a time limit from the format or reset command;
within the time limit:
means for setting a bitmap for a plurality of memory regions; and
means for performing deallocation or reset of zones of at least a portion of the plurality of memory regions, according to the bitmap; and
means for returning a command completion to the host system.
